(19) United States
(12) Patent Application Publication
(10) Pub. No.: US 2018/0032215 A1
(43) Pub. Date: Feb. 1, 2018

(54) AUTOMATIC PARTITIONING OF A LIST FOR EFFICIENT LIST NAVIGATION

(71) Applicant: Microsoft Technology Licensing, LLC., Redmond, WA (US)

(72) Inventor: Anurag Rao, Hyderabad (IN)

(73) Assignee: Microsoft Technology Licensing, LLC., Redmond, WA (US)

(21) Appl. No.: 15/224,299

(22) Filed: Jul. 29, 2016

(51) Int. Cl. G06F 3/0482; G06F 3/01; G06F 3/0484; G06F 3/0485

(52) U.S. Cl. CPC G06F 3/0482; G06F 3/04855; G06F 3/017; G06F 3/04847

(57) ABSTRACT

Automatic partitioning of a list for efficient list navigation is provided. A list is automatically partitioned into sections and increasingly-refined subsections. A user-selection of a section is received, and the list partitioning system scrolls the list to the selected section or filters the list to the selected section. Refinement input in the form of a sliding movement of a user-controlled cursor along an axis perpendicular to the list is received, and the system provides a display of refinement criteria in the form of a first level of refined subsections of the selected section. Upon receiving a selection of a refined subsection, the system scrolls the list to the selected subsection or filters the list to the selected subsection. The list can be continually navigated to a next level of refined subsections until a last level of subsection-refinement is reached, or until the user makes a selection of a list item.

### BACKGROUND

Searching through long sorted lists on a computing device can be tedious and frustrating to a user. When scrolling through a sorted list of items, such as contacts list, a music or movie titles list, online store items, a bill of materials, a dictionary, etc., multiple inputs (e.g., text input, swipes, scrolling gestures, clicks) may have to be made by a user to arrive at and select a desired item.

Currently, a user may enter text input (e.g., via a displayed or physical keyboard) into a search field to search through a list, and the list-providing application may filter the list based on the received input, and display list items that start with the received text input. As can be appreciated, entering text can be cumbersome, particularly on small form devices, such as mobile phones, tablets, or wearable devices, where screen space is limited.

Another current method may include dividing a list into sections, and scrolling to those sections based on user input. For example, some sorted lists include a scrollbar and a scroll indicator, which indicates how long the list is and at which position the list is scrolled. A user may be able to swipe up and down the list, move the indicator to scroll through the list, or move the indicator to a particular section to scroll the list to a corresponding position automatically.

As another example, a scrollbar may be provided as an alphabet, a numbered list, or other sectioned bar displayed on a side of a screen, which allows the user to tap on or select the first letter, number, or section of a desired item to jump to a section of the list comprising items beginning with the selected letter. While this is a helpful feature, sections in a long list can include a considerable number of items, which still requires numerous inputs by the user to find the desired item, particularly when the desired item it near the end of the section.

### SUMMARY

This summary is provided to introduce a selection of concepts in a simplified form that are further described below in the Detailed Description section. This summary is not intended to identify all key or essential features of the claimed subject matter, nor is it intended as an aid in determining the scope of the claimed subject matter.

In this disclosure, automatic partitioning of a list for efficient list navigation is described. Aspects are directed to an automated system, computer-implemented method, and computer storage medium for automatically partitioning a list into sections and increasingly refined subsections for enabling improved list navigation on a computing device. For example, in response to receiving a user selection of a section of a list, a list partitioning system scrolls the list to the selected section or filters the list to the selected section.

Further in response to receiving refinement user input in the form of a sliding movement of a user-controlled cursor along an axis perpendicular to an axis of sequential display of the list items in the user interface, the list partitioning system provides a display of refinement criteria in the form of a first level of refined subsections of the selected section, receives a selection of a refined subsection, and scrolls the list to the selected subsection or filters the list to the selected subsection. A user is enabled to continually be provided with a next level of refined subsections within a selected subsection to selectively navigate or filter the list to by continuing to provide refinement user input until a last level of subsection refinement is reached, or until the user makes a selection of a list item.

Accordingly, a user is advantageously enabled to quickly and intuitively navigate through a list to find a particular list item without having to scroll through a large number of list items. Further computing efficiency is increased due to fewer required processing steps compared to navigating a long list to continually scrolling through the list or through long sections of list items to find a particular list item.

Examples are implemented as a computer process, a computing system, or as an article of manufacture such as a device, computer program product, or computer readable medium. According to an aspect, the computer program product is a computer storage medium readable by a computer system and encoding a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is an illustration of an example operating environment in which automatic list partitioning is provided;

FIG. 2 is an illustration of components of an example list partitioning system;

FIGS. 3A-3C are illustrations showing example user interface displays as a list is efficiently navigated in response to refinement input along a first and second axis;

FIG. 4 is a flow chart showing general stages involved in an example method for automatically partitioning a list for efficient list navigation;

FIG. 5 is a block diagram illustrating example physical components of a computing device;

FIGS. 6A and 6B are block diagrams of a mobile computing device; and

FIG. 7 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

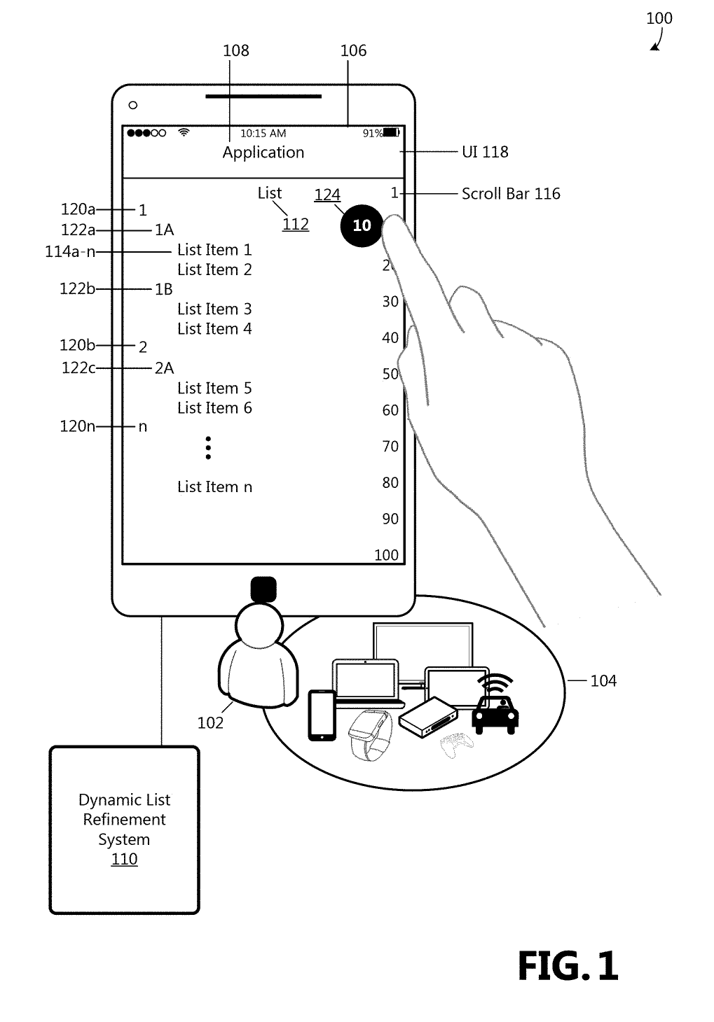

With reference now to FIG. 1, a block diagram illustrating aspects of an example operating environment 100 is shown. The example operating environment 100 includes a computing device 104. The computing device 104 may be one of various types of computing devices for executing applications 108 for performing a variety of tasks. Non-limiting examples of suitable computing devices 104 include desktop computers, laptop computers, tablet computers, laptop/tablet hybrid computing devices, large screen multi-touch displays, mobile phones, personal digital assistants, wearable devices, gaming devices, connected automobiles, and smart appliances. Although examples are illustrated as displayed on a mobile computing device, it should be appreciated that the illustrated examples are not intended to be limiting of the various types of suitable computing devices 104 which may be used to provide automatic list partitioning as described herein.

The example operating environment 100 includes one or more applications 108. Examples of suitable applications 108 include, but are not limited to, word processing, spreadsheet, database, slide presentation, electronic mail, drawing, note taking, web browser, media player, contacts, and game applications. In some examples, the application(s) 108 are web applications run on a server and provided via an online service, for example, a portal-based computing system for creating, managing and sharing electronic documents.

According to an aspect, the computing device 104 comprises or is in communication with a list partitioning system 110, illustrative of a software module, system, or device operative to partition a list 112 into sections 120a-n (collectively, 120) and increasingly refined subsections 122a-n (collectively, 122), which can be automatically scrolled to based on user input. In some examples, the list partitioning system 110 is located and executed locally on the computing device 104. In other examples, an application programming interface (API) is provided for enabling the application 108 to employ list partitioning via stored instructions. For example, the list partitioning system 110 may be located on a remote server and accessed over a network, such as the Internet or an intranet.

The list 112 may be one of various types of lists, such as a contacts list, a music or movie titles list, a list of online store items, a bill of materials, a dictionary, etc., The list is comprised of a plurality of list items 114a-n (collectively, 114), which may be alphabetic, numeric, or alphanumeric. List items 114 may be partitioned into sections 120 and subsections 122 alphabetically, numerically, or by categories.

For example, if a list 112 is a contacts list provided by a contacts application 108, a section 120 for contacts starting with “A” can be further divided into subsections 122 of contacts whose names starting with “Aa,” “Ab,” “Ac,” “Ad,” etc., or divided into subsections 122 having a lower and upper value (e.g., [“Aa”−“Ae”)[“Ae”−“Ah”)). Each subsection 122 can be repeatedly divided into further refined subsections (e.g., sub-subsections, sub-sub-sections, etc,). When searching through the list 112, the user 102 is enabled to selectively scroll to a section 120, for example, contacts starting with “A” by selecting the letter “A” displayed in association with a scrollbar 116 along a first axis in the computing device display 106 or by selecting an area along the scrollbar that represents a position of contacts starting with “A” in the list 112. The list 112 may be automatically scrolled to the first contact in the list whose name starts with the letter denoted by the selected section 120.

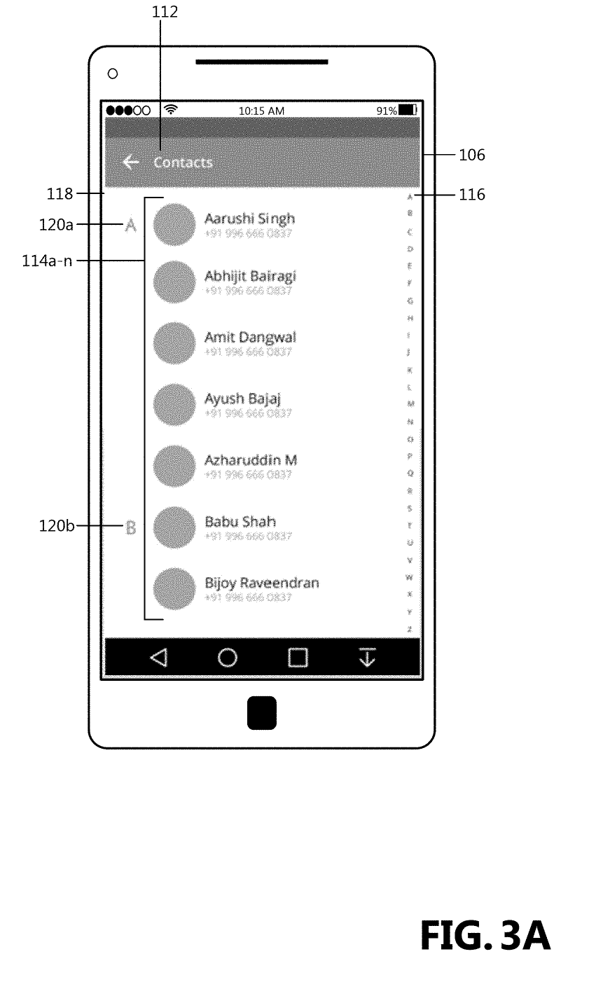

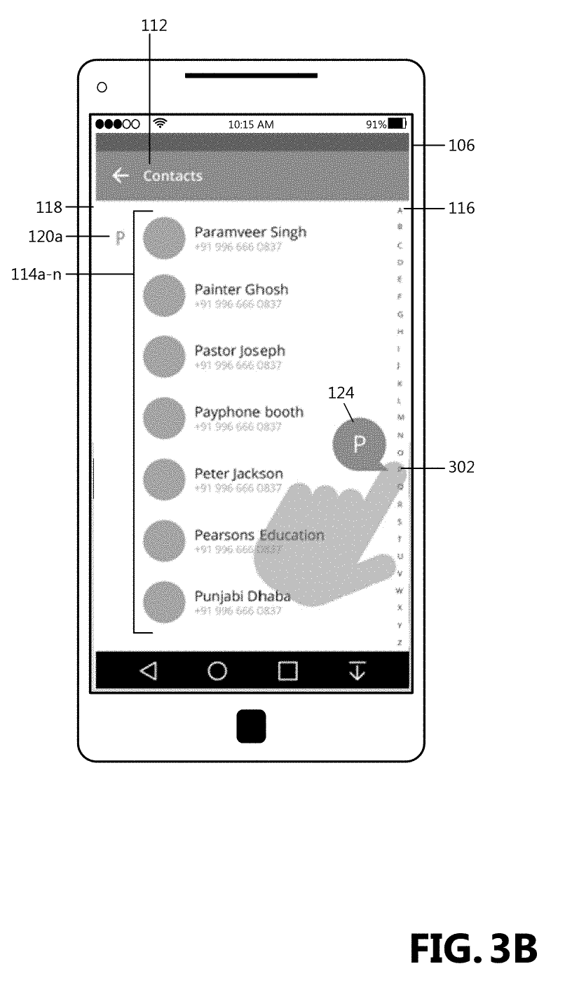

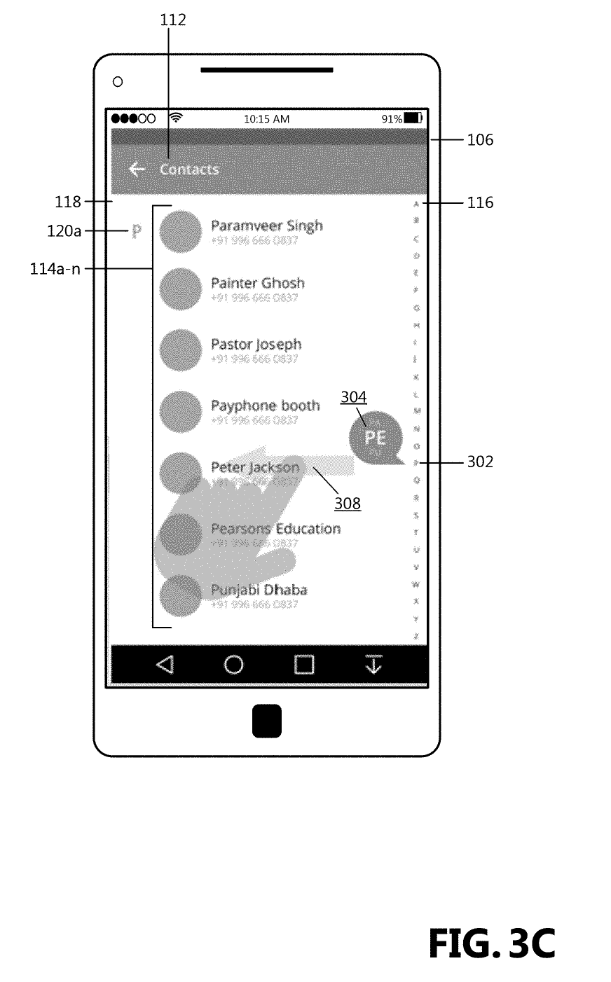

According to an aspect, each list 112 comprises a scrollbar 116 that is displayed along a side of the display 106. The example scrollbar 116 illustrated in FIG. 1 and the example scrollbars illustrated in FIGS. 3A-3C are not limiting of the vast number of different configurations of possible scrollbars that are within the scope of the present disclosure. According to aspects, the scrollbar 116 is displayed along a first axis, wherein the list 112 is displayed along the same first axis. For example, if a list 112 includes list items 114 displayed vertically, the scrollbar 116 is displayed along a Y axis or along a vertical side of the display 106. If the computing device 104 is rotated, the list 112 and scrollbar 116 may also be rotated to keep a same configuration.

In some examples, the scrollbar 116 comprises a scroll indicator 124 that provides an indication of a position, section 120, or subsection 122 that is being selected for scrolling. Further, the scrollbar 116 may be divided into sections, such that each section represents a first character, a first number or group of numbers, or a category of a list item 114. In some examples, section identifiers are displayed along the scrollbar 116 that represent each section. In some examples, section identifiers are dynamically updated based on the position of the user's cursor.

Aspects provide for dynamically refining a list 112 into increasingly refined subsections 122, and automatically scrolling to a refined subsection 122 based on user input. The user input may include input via various input methods, such as those relying on mice, keyboards, and remote controls, as well as Natural User Interface (NUI) methods, which enable a user to interact with a device 104 in a “natural” manner, such as via speech recognition, touch and stylus recognition, gesture recognition both on screen and adjacent to the screen, air gestures, head and eye tracking, voice and speech, vision, touch, hover, gestures, and machine intelligence.

According to an aspect, the user input for automatically scrolling to a refined subsection 122 of a list 112 comprises a directional sliding movement of a user-controlled cursor (such as a mouse cursor, a touch-point on a touch-screen interface, a focus-point on a motion gesture detection device, or head, eye, or gaze tracking device) along two axes. For example, a directional sliding movement of a user-controlled cursor along a first axis (e.g., along a Y axis of the screen 106 of the computing device 104) on or near the scrollbar 116 enables scrolling to and selection of a refinement criteria embodied as a section identifier for automatic scrolling of the list 112 to the section 120 associated with the selected section identifier. Further, a directional sliding movement of the user-controlled cursor along a second axis (e.g., along an X axis of the screen 106 of the computing device 104) provides a display of a next level of refinement criteria embodied as a first level of subsection identifiers within the selected section 120. The user 102 is enabled to provide a directional sliding movement of the user-controlled cursor along the first axis to select a first subsection identifier for automatic scrolling of the list 112 to the subsection 122 associated with the selected first subsection identifier. This may be repeated until a last level of subsection refinement is reached, or until the user makes a selection of a list item 114.

By automatically partitioning a list 112 into increasingly refined subsections 122 and enabling automatic scrolling through the subsections 122 via an intuitive user input, a user 102 is enabled to quickly and easily navigate through various sections 120 and subsections 122 of a list 112 to locate an intended list item 114 with fewer inputs and steps. Computer efficiency for searching for a list item 114 in a list 112 is improved by reducing a number of user inputs for navigating though a list 112, for example, particularly when searching for an item in a long list 112 where a user 102 may have to scroll through a large number of list items 114 for find a desired list item 114. Accordingly, when searching for a particular list item 114, the number of list items 114 a user 102 has to navigate through to locate the particular list item 114 is reduced, and user interaction performance is increased.

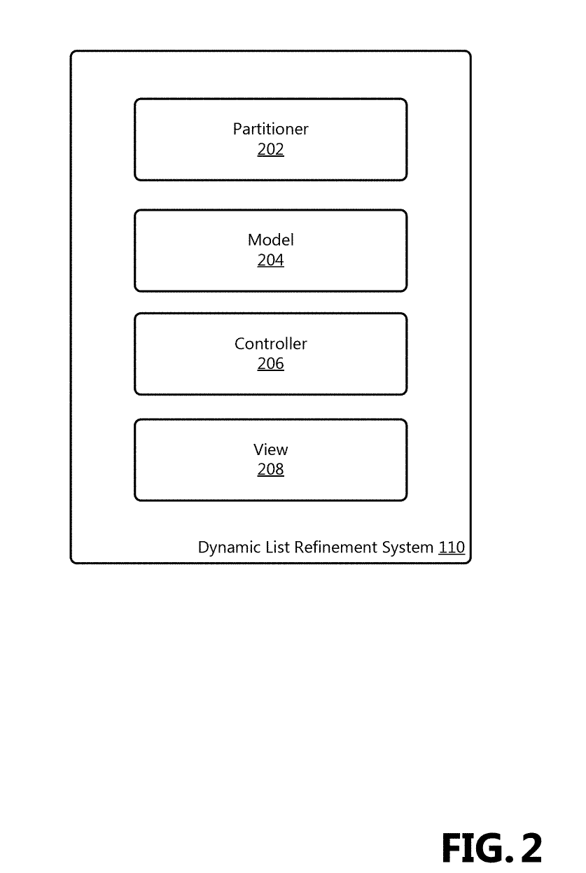

With reference now to FIG. 2, various components of an example list partitioning system 110 are illustrated. According to an aspect, the list partitioning system 110 comprises a partitioner 202, illustrative of a software module, system, or device operative to partition or transform the list 120 into various levels (i.e., sections 120 and subsections 122) for creating a data structure for searching based on user input. In some examples, the partitioner 202 partitions the list 112 into sections 120 and subsections 122 prior to a user 102 navigating the list 112. In other examples, the partitioner 202 is operative to partition the list 112 into sections 120 and subsections 122 dynamically as the user 102 is navigating the list 112. In other examples, the partitioner 202 is operative to partition the list 112 into sections 120 prior to the user navigating the list 112, and to partition the sections 120 into subsections 122 dynamically as the user 102 is navigating the list 112.

In one example, to represent a section 120 or subsection 122, the partitioner 202 defines a level of the section 120 or subsection 122, lower and upper bound section or subsection values (Vₗ and Vᵤ), a position in the list 112 of the first list item 114 of the section or subsection, and a link to the next higher level section 120 or subsection 122 of the list 112. The partitioned data can be thought of as a diverging list of lists. Starting at a first level (list sections 120), the partitioner 202 constructs a section level list S₁. For each list item 114 in S₁, the partitioner 202 constructs a first subsection 122 level list SS₁, and links it back to the parent. The process continues until it has partitioned the list 112 over a network 120, such as the Internet or an intranet up to level N, where N is the number of list items 114 in the list 112.

According to an example, for each list item 114 in the list 112, the partitioner 202 uses the list item 144 and the current section 120 or subsection 122 being created to return a value indicating whether the list item 114 belongs to the section 120 or subsection 122 or not. If the list item 114 belongs to the section 120 or subsection 122, the partitioner 202 moves one level lower within the same section 120 or subsection 122, and inquires about the list item's membership to an inner partition list. If at any point a list item 114 does not belong to a subsection 122, a new subsection entry is created with the position of the current list item 144. The new subsection entry is added to the current subsection list. The partitioned data is indexed and stored by a model 204.

For example, if a section 120 (level 1) is defined with a lower value Vₗ of 0 and an upper value Vᵤ of 1, the section 120 is defined by the level and two boundary values (V|VεN, 0.0<=V<1.0), wherein the lower value Vₗ is inclusive and the upper value Vᵤ is exclusive. As should be appreciated, this is one example; other variations of defining sections and subsections are within the scope of the disclosure.

As an example, in a list 112 comprising 100 list items 114, the first level of partitioning (first level (L=1) or section S₁) may include sections 120: [0.0, 0.2), [0.2, 0.6), [0.6, 0.7), [0.7, 1.0). The second section [0.2, 0.6) may be further divided into a second level (L=2) or first subsection level SS₁ including subsections 122: [0.2, 0.3), [0.3, 0.5), [0.5, 0.6).

According to an aspect, the list partitioning system 110 comprises a model 204, illustrative of a software module, system, or device operative to index and store the partitioned data. The model 204 provides methods to add the partitioned data to a data store, and return a position of a list item 114 based on a selected level (L) and section 120 or subsection 122 value (V).

According to an aspect, the list partitioning system 110 comprises a controller 206, illustrative of a software module, system, or device operative to, with the help of the partitioner 202, transform the list data provided by the application 108, and store it in the model 204. In addition, with the help of the model 204, the controller 206 directs a UI component (i.e., view 208) to update a display of the user interface 118 based on input provided to it. According to an aspect, the view 208 is illustrative of a software module, system, or device operative to display the list 112 and list items 114, pass user input to the controller 206, and update the user interface 118 display as directed by the controller.

According to an aspect, the model 204 is operative to return a position of the first list item 114 in a section 120 or subsection 122 based on user input (e.g., selection of a section or subsection identifier associated with the scrollbar 116). For example, the model 204 performs a search for a first list item 114 in a section 120 or subsection 122 based on a selected level (L) and section or subsection value (V).

Continuing with the example subdivided list 112 described above, if a user input along the scrollbar 116 corresponds to a value of V=0.3 at L=1 (S₁), the model 204 is operative to return a position of the first list item 114 in the section 120 comprising the selected value (0.3) is 0.2 in the section [0.2, 0.6). Accordingly, the controller 206 scrolls the list 112 to 0.2 (the first list item 114 in the section 120), and directs the view 208 to update the display of the user interface 118 to display the list scrolled to 0.2. In some examples, the controller 206 is operative to filter the list 112 according to the selected section 120. For example, only list items 114 responsive to the selected section 120 are displayed in the user interface 118.

Continuing with the example, the user 102 may provide a user input, such as a directional sliding movement of a user-controlled cursor along the axis of display of the scrollbar 116 to select a value V within the list 112, and then provide a next user input, such as a directional sliding movement of a user-controlled cursor along an axis perpendicular to the axis of display of the scrollbar 116, for providing options for navigating the list to a next level L=2 (first subsection SS₁). For example, the user 102 may move the user-controlled cursor to V=0.45. Accordingly, with inputs of L=2 and V=0.45, the list partitioning system 110 is operative to provide a display of subsection identifiers corresponding to subsections 122 present on the level. According to an example, the subsection identifiers may identify the lower bound Vₗ of the subsections 122. For example, the list partitioning system 110 may provide a display of a first subsection identifier 0.2 corresponding to a first subsection [0.2, 0.3), a second subsection identifier 0.3 corresponding to a second subsection [0.3, 0.5), and a third subsection identifier 0.5 corresponding to a third subsection [0.5, 0.6).

The user 102 may then provide a user input, such as a directional sliding movement of a user-controlled cursor along the axis of display of the scrollbar 116 to select a subsection 122 via a selection of a subsection identifier. Accordingly, the controller 206 scrolls the list 112 to the first list item 114 in the selected subsection 122, and directs the view 208 to update the display of the user interface 118 to display the list 112 scrolled to the first list item 114 in the selected subsection 122. In some examples, the controller 206 is operative to filter the list 112 according to the selected subsection 122. For example, only list items 114 responsive to the selected subsection 122 are displayed in the user interface 118. Refining search criteria dynamically into partitioned subsections 122 and navigating the list 112 to selected subsections may be repeated until until a last level of subsection refinement is reached, or until the user makes a selection of a list item 114.

In some examples, a modified binary search is used to find the section 120 or subsection 122 comprising the selected section or subsection value (V). Each section or subsection list is ordered as per the partitions present on that level, and the model 204 uses the lower partition value, Vₗ, to perform the search.

For example, given the partition, the model 204 starts from the top most partition list, P₁, and performs a standard binary search until the invariant (i.e., l<u) holds. Once the search is over, either l or u (whichever is lower) is the required partition. If the level of the partition list is the same as the input, the model 204 stops the search. If the level of the partition list is not the same as the input, the model 204 goes one level deeper using the partition list link, and continues the search until it has the required partition at the required level.

FIG. 3A is an illustration of an application user interface 118 including an example list 112 comprising a plurality of list items 114, in this example, a contacts list comprising a plurality of contact names arranged in alphabetical order. As illustrated, a scrollbar 116 is provided, which is displayed along a vertical edge of the display 106 parallel to the list 112, and is sectioned according to a first level of refinement (S₁). For example, the scrollbar 116 is sectioned by alphabetically-arranged characters that denote the first character of a contact's name.

FIG. 3B shows the user 102 selecting a first level section identifier 302 (e.g., character “P”) in the scrollbar 116. As illustrated, an example scroll indicator 124 is provided that indicates or highlights the selected section identifier 302. Also as illustrated, responsive to the selection of the section identifier 302, the display of the list 112 in the UI 118 is updated reflecting the scrolling of the list to the section 120 associated with the selected section identifier. For example, the list 112 is automatically scrolled to the first contact (i.e., list item 114) in the list starting with the letter denoted by the selected section identifier 302.

With reference now to FIG. 3C, the user 102 then slides a finger along a second axis (e.g., horizontally), which is received as a refinement input 308 that causes the list partitioning system 110 to provide selectable subsections 122 within a selected section 120 from which the user 102 is enabled to select a desired subsection to which to navigate. The user 102 is enabled to slide a finger along the first axis (e.g., vertically) to select a first subsection identifier 304, which in the illustrated example is “Pe.” Responsive to the second-selected identifier (i.e., the first subsection identifier 304), the list 112 is updated and scrolled to the first contact (i.e., list item 114) in the list starting with the letters denoted by the selected first subsection identifier 304 “Pe.” The horizontal and vertical scrolling for refining search criteria for navigating the list 112 can be repeated until the user 102 stops scrolling horizontally, until a last level of subsection refinement is reached, or until the user makes a selection of a list item 114.

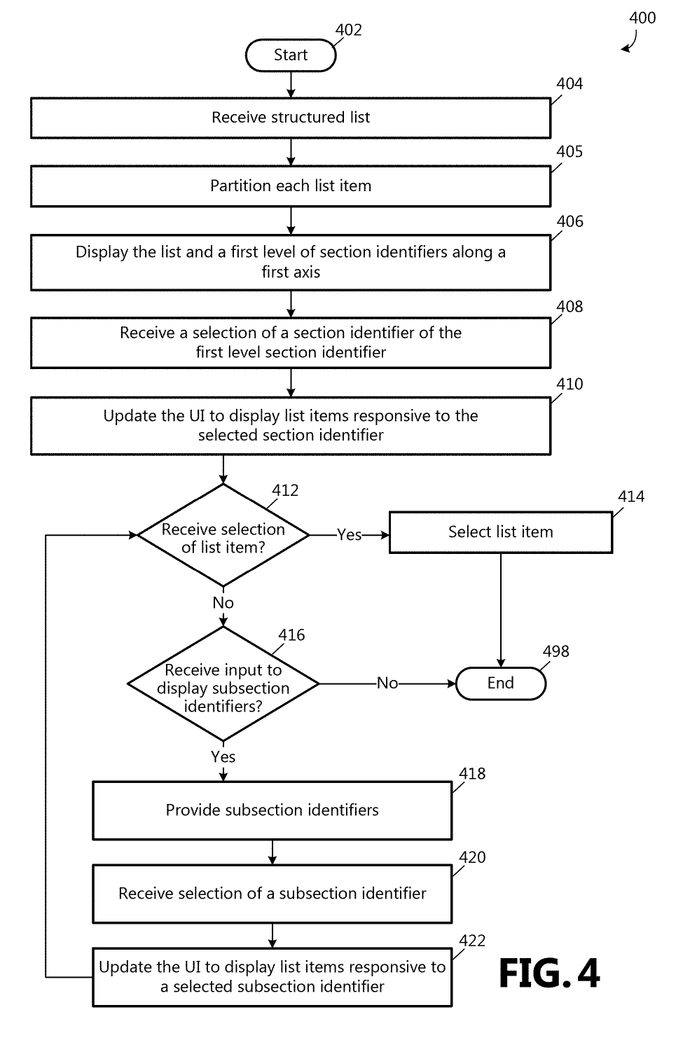

FIG. 4 is a flow chart showing general stages involved in an example method 400 for automatically partitioning a list for efficient list navigation. Method 400 beings at OPERATION 402, and proceeds to OPERATION 404, where a structured list 112 comprising a plurality of list items 114 is received from an application 108.

The method 400 proceeds to OPERATION 405, where the list 112 is partitioned into sections 120 comprising subsets of the plurality of list items 114, and partitions each section 120 into subsections 122, wherein each subsection 122 comprises a refined subset of the plurality of list items comprising a given section 120. For example, for each list item 114, a level, the lower and upper bound partition values (Vₗ and Vᵤ), the position in the list 112 of the first element of each subsection 122, and a link to the next level partition list is determined. In some examples, this step is performed dynamically as a user 102 is navigating the list 112.

At OPERATION 406, the list 112 is displayed in the application UI 118, and a first level of section identifiers 302 are displayed along a first axis of the display 106. According to an example, the section identifiers 302 are displayed along the scrollbar 116. At OPERATION 408, a selection of a section identifier 302 from the first level of section identifiers 302 is received. Responsive to the selection, at OPERATION 410, the list 112 is scrolled to a first list item 114 in the section 120 corresponding to the selected criterion. In some examples, the list 112 is filtered to display list items 114 in the section 120 corresponding to the selected criterion.

At DECISION OPERATION 412, a determination is made as to whether a list item 114 is selected by the user 102. When a list item 114 is selected by the user 102, the method 400 continues to OPERATION 414, where the list item 114 is selected by the application 108. When a determination is made that a list item 114 has not been selected, the method 400 continues to DECISION OPERATION 416, where a determination is made as to whether user input is received for refining search criteria for navigating the list 112 (refinement input 308). For example, a determination is made as to whether a sliding movement of a user-controlled cursor along an axis perpendicular to the axis of sequential display of the list items 114 in the user interface (e.g., along the axis perpendicular to the axis of display of the list 112, scrollbar 116, and section identifiers 302) is received.

When refinement input 308 is not received, the method 400 ends at OPERATION 498. When a determination is made that user input for refining search criteria to a subsection 122 of list items 114 within the selected section 120 is received, the method 400 proceeds to OPERATION 418, where a plurality of subsection identifiers 304 corresponding to subsections 122 within the selected section 120 are displayed. For example, the subsections 122 include subsections 122 determined by the partitioner 202 at OPERATION 405.

The method 400 proceeds to OPERATION 420, where a selection of a subsection identifier 304 is received. For example, the user 102 may provide a user input, such as a directional sliding movement of a user-controlled cursor along the axis of sequential display of the list items in the user interface 118 via a selection of a displayed subsection identifier 304.

In response, at OPERATION 422, the controller 206 directs the view 208 to update the display of the user interface 118 to display the list scrolled to the first list item 114 in the selected subsection 122, thus advancing the search or navigation to a next subsection level. In some examples, the controller 206 is operative to filter the list 112 according to the selected subsection 122. The method 400 may then return to DECISION OPERATION 412, and may repeat until the user 102 stops providing refinement input 308, until a last level of subsection refinement is reached, or until the user makes a selection of a list item 114. For example, when a next refinement input is received (OPERATION 416), the list refinement system 110 displays a next level of refinement criteria comprising sub-subsection identifiers corresponding to a sub-subsection into which the list items are portioned within the selected subsection 122 (OPERATION 418). When a selection of a sub-subsection identifier is received (OPERATION 420), the system 110 identifies the first list item 114 in the sub-subsection corresponding to the selected sub-subsection identifier, and updates the user interface 118 to display the list 112 scrolled to the identified first list item 114 in the sub-subsection corresponding to the selected sub-subsection identifier (OPERATION 422).

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

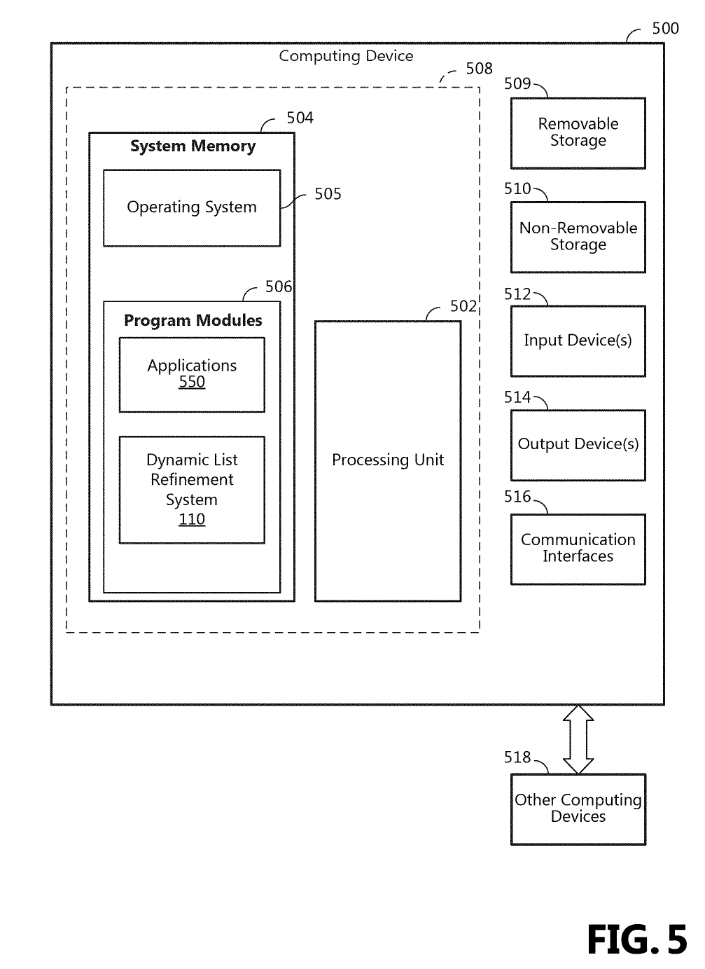

FIGS. 5-7 and the associated descriptions provide a discussion of a variety of operating environments in which examples are practiced. However, the devices and systems illustrated and discussed with respect to FIGS. 5-7 are for purposes of example and illustration and are not limiting of a vast number of computing device configurations that are used for practicing aspects, described herein.

FIG. 5 is a block diagram illustrating physical components (i.e., hardware) of a computing device 500 with which examples of the present disclosure may be practiced. In a basic configuration, the computing device 500 includes at least one processing unit 502 and a system memory 504. According to an aspect, depending on the configuration and type of computing device, the system memory 504 comprises, but is not limited to, volatile storage (e.g., random access memory), non-volatile storage (e.g., read-only memory), flash memory, or any combination of such memories. According to an aspect, the system memory 504 includes an operating system 505 and one or more program modules 506 suitable for running software applications 550. According to an aspect, the system memory 504 includes a list partitioning system 110. The operating system 505, for example, is suitable for controlling the operation of the computing device 500. Furthermore, aspects are practiced in conjunction with a graphics library, other operating systems, or any other application program, and are not limited to any particular application or system. This basic configuration is illustrated in FIG. 5 by those components within a dashed line 508. According to an aspect, the computing device 500 has additional features or functionality. For example, according to an aspect, the computing device 500 includes additional data storage devices (removable and/or non-removable) such as, for example, magnetic disks, optical disks, or tape. Such additional storage is illustrated in FIG. 5 by a removable storage device 509 and a non-removable storage device 510.

As stated above, according to an aspect, a number of program modules and data files are stored in the system memory 504. While executing on the processing unit 502, the program modules 506 (e.g., a list partitioning system 110) perform processes including, but not limited to, one or more of the stages of the methods discussed herein. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit using a microprocessor, or on a single chip containing electronic elements or microprocessors. For example, aspects are practiced via a system-on-a-chip (SOC) where each or many of the components illustrated in FIG. 5 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 500 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 500 has one or more input device(s) 512 such as a keyboard, a mouse, a pen, a sound input device, a touch input device, etc. The output device(s) 514 such as a display, speakers, a printer, etc. are also included according to an aspect. The aforementioned devices are examples and others may be used. According to an aspect, the computing device 500 includes one or more communication connections 516 allowing communications with other computing devices 518. Examples of suitable communication connections 516 include, but are not limited to, radio frequency (RF) transmitter, receiver, and/or transceiver circuitry; universal serial bus (USB), parallel, and/or serial ports.

The term computer readable media, as used herein, includes computer storage media. Computer storage media include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. According to an aspect, any such computer storage media is part of the computing device 500. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

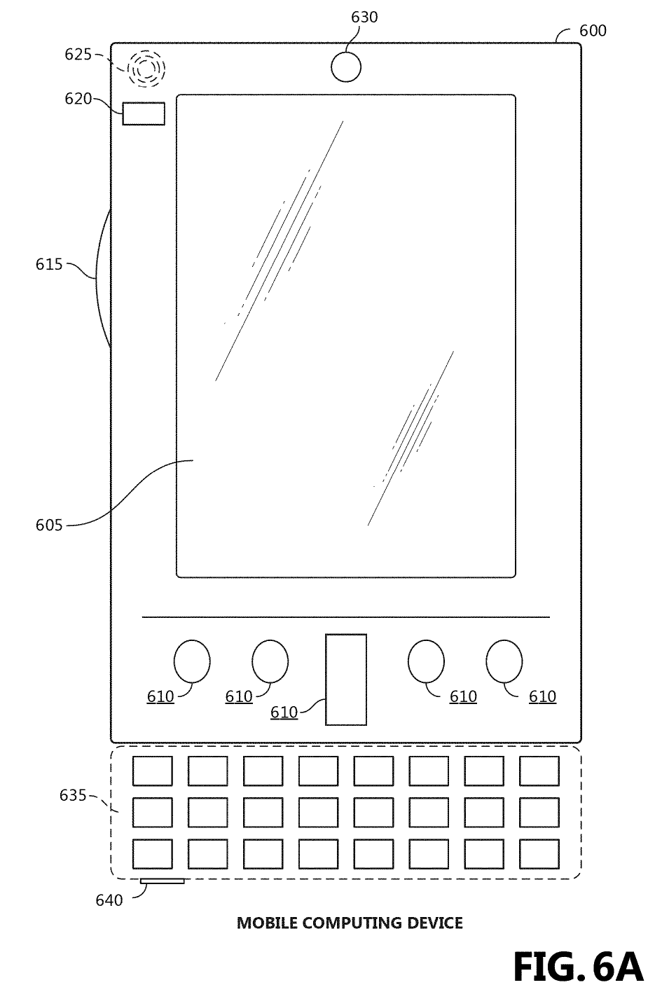

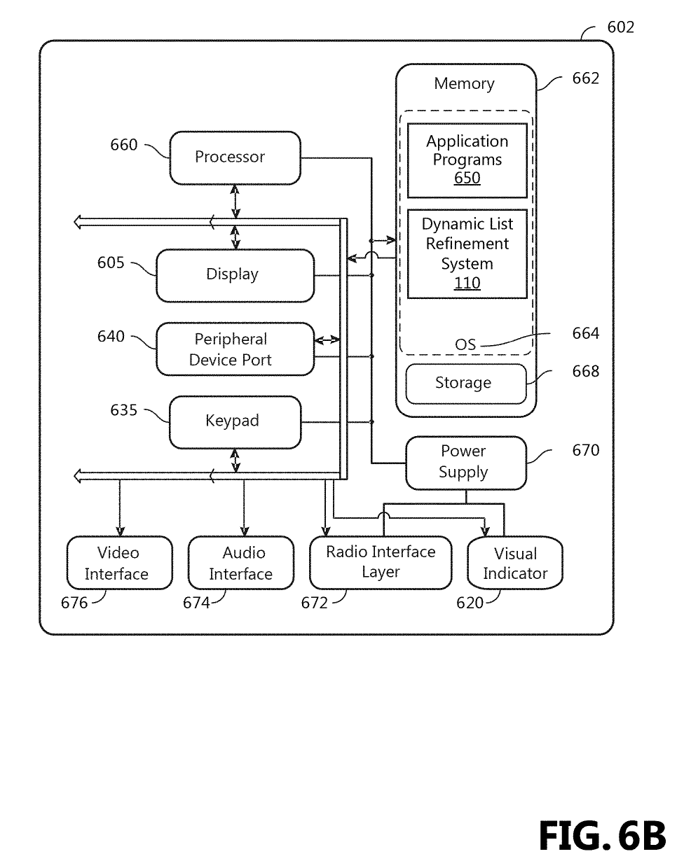

FIGS. 6A and 6B illustrate a mobile computing device 600, for example, a mobile telephone, a smart phone, a tablet personal computer, a laptop computer, and the like, with which aspects may be practiced. With reference to FIG. 6A, an example of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. According to an aspect, the display 605 of the mobile computing device 600 functions as an input device (e.g., a touch screen display). If included, an optional side input element 615 allows further user input. According to an aspect, the side input element 615 is a rotary switch, a button, or any other type of manual input element. In alternative examples, mobile computing device 600 incorporates more or fewer input elements. For example, the display 605 may not be a touch screen in some examples. In alternative examples, the mobile computing device 600 is a portable phone system, such as a cellular phone. According to an aspect, the mobile computing device 600 includes an optional keypad 635. According to an aspect, the optional keypad 635 is a physical keypad. According to another aspect, the optional keypad 635 is a “soft” keypad generated on the touch screen display. In various aspects, the output elements include the display 605 for showing a graphical user interface (GUI), a visual indicator 620 (e.g., a light emitting diode), and/or an audio transducer 625 (e.g., a speaker). In some examples, the mobile computing device 600 incorporates a vibration transducer for providing the user with tactile feedback. In yet another example, the mobile computing device 600 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 600 incorporates peripheral device port 640, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one example of a mobile computing device. That is, the mobile computing device 600 incorporates a system (i.e., an architecture) 602 to implement some examples. In one example, the system 602 is implemented as a “smart phone” capable of running one or more applications (e.g., browser, e-mail, calendaring, contact managers, messaging clients, games, and media clients/players). In some examples, the system 602 is integrated as a computing device, such as an integrated personal digital assistant (PDA) and wireless phone.

According to an aspect, one or more application programs 650 are loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. According to an aspect, a list partitioning system 110 is loaded into memory 662. The system 602 also includes a non-volatile storage area 668 within the memory 662. The non-volatile storage area 668 is used to store persistent information that should not be lost if the system 602 is powered down. The application programs 650 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

According to an aspect, the system 602 has a power supply 670, which is implemented as one or more batteries. According to an aspect, the power supply 670 further includes an external power source, such as an AC adapter or a powered docking cradle that supplements or recharges the batteries.

According to an aspect, the system 602 includes a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 650 via the operating system 664, and vice versa.

According to an aspect, the visual indicator 620 is used to provide visual notifications and/or an audio interface 674 is used for producing audible notifications via the audio transducer 625. In the illustrated example, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. According to an aspect, the system 602 further includes a video interface 676 that enables an operation of an on-board camera 630 to record still images, video stream, and the like.

According to an aspect, a mobile computing device 600 implementing the system 602 has additional features or functionality. For example, the mobile computing device 600 includes additional data storage devices (removable and/or non-removable) such as, magnetic disks, optical disks, or tape. Such additional storage is illustrated in FIG. 6B by the non-volatile storage area 668.

According to an aspect, data/information generated or captured by the mobile computing device 600 and stored via the system 602 are stored locally on the mobile computing device 600, as described above. According to another aspect, the data are stored on any number of storage media that are accessible by the device via the radio 672 or via a wired connection between the mobile computing device 600 and a separate computing device associated with the mobile computing device 600, for example, a server computer in a distributed computing network, such as the Internet. As should be appreciated such data/information are accessible via the mobile computing device 600 via the radio 672 or via a distributed computing network. Similarly, according to an aspect, such data/information are readily transferred between computing devices for storage and use according to well-known data/information transfer and storage means, including electronic mail and collaborative data/information sharing systems.

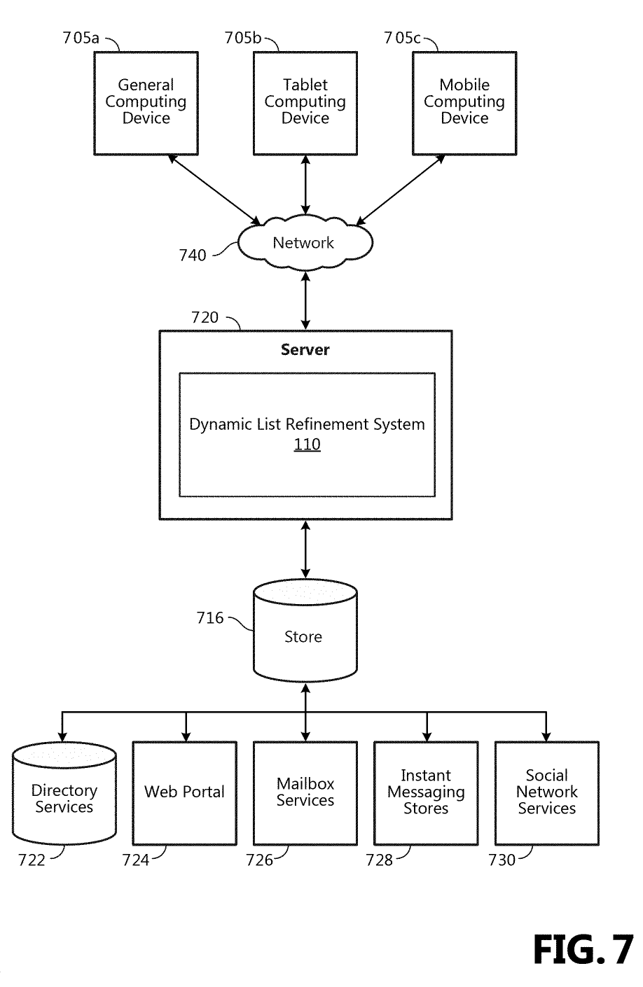

FIG. 7 illustrates one example of the architecture of a system for automatically partitioning a list for efficient list navigation as described above. Content developed, interacted with, or edited in association with the list partitioning system 110 is enabled to be stored in different communication channels or other storage types. For example, various documents may be stored using a directory service 722, a web portal 724, a mailbox service 726, an instant messaging store 728, or a social networking site 730. The list partitioning system 110 is operative to use any of these types of systems or the like for partitioning a list, as described herein. According to an aspect, a server 720 provides the list partitioning system 110 to clients 705a,b,c. As one example, the server 720 is a web server providing the list partitioning system 110 over the web. The server 720 provides the list partitioning system 110 over the web to clients 705 through a network 740. By way of example, the client computing device is implemented and embodied in a personal computer 705a, a tablet computing device 705b or a mobile computing device 705c (e.g., a smart phone), or other computing device. Any of these examples of the client computing device are operable to obtain content from the store 716.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

1. A computer-implemented method for automatically partitioning a list for efficient list navigation, comprising:
receiving the list, the list comprising a plurality of list items;
partitioning the list into sections comprising subsets of the plurality of list items;
partitioning each section into subsections, wherein each subsection comprises a refined subset of the plurality of list items comprising a given section;
displaying the list in a user interface of an application along an axis of sequential display of the list items in the user interface;
displaying a first level of refinement criteria, the first level of refinement criteria comprising section identifiers corresponding to the sections into which the list items are partitioned;
receiving a selection of a section identifier;
responsive to the selection of the section identifier, updating the user interface to display the list scrolled to the section corresponding to the selected section identifier;
receiving a refinement input, wherein the refinement input comprises a sliding movement of a user-controlled cursor along an axis perpendicular to the axis of sequential display of the list items in the user interface;
responsive to the refinement input, displaying a next level of refinement criteria, the next level of refinement criteria comprising subsection identifiers corresponding to a next level of subsections into which the list items are partitioned within the selected section;
receiving a selection of a subsection identifier; and
responsive to the selection of the subsection identifier, updating the user interface to display the list scrolled to the subsection corresponding to the selected subsection identifier.

2. The computer-implemented method of claim 1, wherein updating the user interface to display the list scrolled to the section corresponding to the selected section identifier comprises:
identifying a first list item in the section corresponding to the selected section identifier; and
updating the user interface to display the list scrolled to the identified first list item in the section.

3. The computer-implemented method of claim 1, wherein updating the user interface to display the list scrolled to the subsection corresponding to the selected subsection identifier comprises:
identifying a first list item in the subsection corresponding to the selected subsection identifier; and
updating the user interface to display the list scrolled to the identified first list item in the subsection.

4. The computer-implemented method of claim 1, further comprising:
partitioning each subsection into sub-subsections, wherein each sub-subsection comprises a further refined subset of the plurality of list items comprising a given subsection;
receiving a next refinement input, wherein the next refinement input comprises a sliding movement of a user-controlled cursor along the axis perpendicular to the axis of sequential display of the list items in the user interface;
responsive to the next refinement input, displaying a next level of refinement criteria, the next level of refinement criteria comprising sub-subsection identifiers corresponding to a sub-subsection into which the list items are partitioned within the selected subsection;
receiving a selection of a sub-subsection identifier;
responsive to the selection of the sub-subsection identifier, identifying a first list item in the sub-subsection corresponding to the selected sub-subsection identifier; and
updating the user interface to display the list scrolled to the identified first list item in the sub-subsection corresponding to the selected sub-subsection identifier.

5. The computer-implemented method of claim 1, wherein:
updating the user interface to display the list scrolled to the section corresponding to the selected section identifier further comprises filtering out sections other than the section corresponding to the selected section identifier; and
updating the user interface to display the list scrolled to the subsection corresponding to the selected subsection identifier further comprises filtering out subsections other than the subsection corresponding to the selected subsection identifier.

6. The computer-implemented method of claim 1, wherein partitioning comprises:
defining a level of each section and subsection;
defining a lower bound section value and an upper bound section value for each section and subsection; and
identifying a position in the list of the first list item of each section and subsection.

7. The computer-implemented method of claim 1, wherein displaying a first level of refinement criteria comprises displaying the first level of refinement criteria along an axis parallel to the axis of sequential display of the list items in the user interface.

8. The computer-implemented method of claim 5, wherein displaying a first level of refinement criteria comprises displaying an characters, numbers, or categories.

9. A device for automatically partitioning a list for efficient list navigation, the device comprising a list partitioning system, the list partitioning system comprising:
a partitioner, operative to:
receive the list, the list comprising a plurality of list items;
partition the list into sections comprising subsets of the plurality of list items; and
partition each section into subsections, wherein each subsection comprises a refined subset of the plurality of list items comprising a given section;
a model, operative to:
store the sections and the subsections;
a view, operative to:
display the list in a user interface of an application along an axis of sequential display of the list items in the user interface;
display a first level of refinement criteria, the first level of refinement criteria comprising section identifiers corresponding to the sections to which the list items are partitioned; and
receive a selection of a section identifier; and
a controller, operative to:
responsive to the selection of the section identifier, direct the view to update the user interface to display the list scrolled to the section corresponding to the selected section identifier.

10. The device of claim 9, wherein:
the view is further operative to:
receive a refinement input, wherein the refinement input comprises a sliding movement of a user-controlled cursor along an axis perpendicular to the axis of sequential display of the list items in the user interface;
responsive to the refinement input, display a next level of refinement criteria, the next level of refinement criteria comprising subsection identifiers corresponding to a next level of subsections to which the list items are partitioned within the selected section; and
receive a selection of a subsection identifier; and
the controller is further operative to:
responsive to the selection of the subsection identifier, direct the view to update the user interface to display the list scrolled to the subsection corresponding to the selected subsection identifier.

11. The device of claim 10, wherein in directing the view to update the user interface to display the list scrolled to the subsection corresponding to the selected subsection identifier, the controller is operative to:
identify a first list item in the subsection corresponding to the selected subsection identifier; and
direct the view to update the user interface to display the list scrolled to the identified first list item in the subsection.

12. The device of claim 11, wherein the view is further operative to update the user interface to display the list scrolled to the identified first list item in the subsection corresponding to the selected subsection identifier.

13. The device of claim 10, wherein in updating the user interface to display the list scrolled to the subsection corresponding to the selected subsection identifier, the view is further operative to filter out subsections other than the subsection corresponding to the selected subsection identifier.

14. The device of claim 9, wherein in directing the view to update the user interface to display the list scrolled to the section corresponding to the selected section identifier, the controller is operative to:
identify a first list item in the section corresponding to the selected section identifier; and
direct the view to update the user interface to display the list scrolled to the identified first list item in the section.

15. The device of claim 14, wherein the view is further operative to update the user interface to display the list scrolled to the identified first list item in the section corresponding to the selected section identifier.

16. The device of claim 9, wherein in updating the user interface to display the list scrolled to the section corresponding to the selected section identifier, the view is further operative to filter out sections other than the section corresponding to the selected section identifier.

17. The device of claim 9, wherein in partitioning, the partitioner is operative to:
define a level of each section and subsection;
define a lower bound section value and an upper bound section value for each section and subsection; and
identify a position in the list of the first list item of each section and subsection.

18. A computer-readable storage medium including instructions, which when executed by a computer, provides:
receiving the list, the list comprising a plurality of list items;
partitioning the list into sections comprising subsets of the plurality of list items;
partitioning each section into subsections, wherein each subsection comprises a refined subset of the plurality of list items comprising a given section;
displaying the list in a user interface of an application along an axis of sequential display of the list items in the user interface;
displaying a first level of refinement criteria, the first level of refinement criteria comprising section identifiers corresponding to the sections to which the list items are partitioned;
receiving a selection of a section identifier;
responsive to the selection of the section identifier:
identifying a first list item in the section corresponding to the selected section identifier;
updating the user interface to display the list scrolled to the identified first list item in the section corresponding to the selected section identifier;
receiving a refinement input, wherein the refinement input comprises a sliding movement of a user-controlled cursor along an axis perpendicular to the axis of sequential display of the list items in the user interface;
responsive to the refinement input, displaying a next level of refinement criteria, the next level of refinement criteria comprising subsection identifiers corresponding to a next level of subsections to which the list items are partitioned within the selected section;
receiving a selection of a subsection identifier;
responsive to the selection of the subsection identifier, identifying a first list item in the subsection corresponding to the selected subsection identifier; and
updating the user interface to display the list scrolled to the first list item in the subsection corresponding to the selected subsection identifier.

19. The computer-readable storage medium of claim 18, wherein:
updating the user interface to display the list scrolled to the section corresponding to the selected section identifier further comprises filtering out sections other than the section corresponding to the selected section identifier; and
updating the user interface to display the list scrolled to the subsection corresponding to the selected subsection identifier further comprises filtering out subsections other than the subsection corresponding to the selected subsection identifier.

20. The computer-readable storage medium of claim 18, wherein partitioning comprises:
defining a level of each section and subsection;
defining a lower bound section value and an upper bound section value for each section and subsection; and
identifying a position in the list of the first list item of each section and subsection.
